(19) United States
(12) Patent Application Publication
(10) Pub. No.: US 2017/0039604 A1
(43) Pub. Date: Feb. 9, 2017

(54) Tracking Metrics for Display in Advertisements

(71) Applicants: Hobart Sze, Mountain View, CA (US); Dani Suleman, Fremont, CA (US)

(72) Inventors: Hobart Sze, Mountain View, CA (US); Dani Suleman, Fremont, CA (US)

(21) Appl. No.: 13/413,953

(22) Filed: Mar. 7, 2012

(51) Int. Cl. G06Q 30/02

(52) U.S. Cl. CPC G06Q 30/0276

(57) ABSTRACT

A method performed by one or more processing devices includes tracking values of a metric to be displayed in a portion of an advertisement; receiving a request for the advertisement; determining, based on tracking, a value of the metric at a time of the request; and populating the portion of the advertisement with the value of the metric.

### BACKGROUND

A system selects advertisements for display in web pages. In an example, an advertiser uploads to the system an advertisement for products and/or services (collectively referred to herein as products, without limitation, and for purposes of convenience), Generally, an advertiser includes an entity that promotes products. Generally, an advertisement includes content (e.g., words, images, hyperlinks, and so forth) for the promotion of products. An advertisement may also include data specifying an arrangement of the content.

In this example, the advertisement references a discount for a product. The discount has an expiration date, including, e.g., a date after which discount is no longer offered. Following the expiration date, the advertiser removes the advertisement from the system. By removing the advertisement, the advertiser prevents the advertisement from being displayed in web pages after the expiration date of the discount.

### SUMMARY

In one aspect of the present disclosure, a method performed by one or more processing devices includes tracking values of a metric to be displayed in a portion of an advertisement; receiving a request for the advertisement; determining, based on tracking, a value of the metric at a time of the request; and populating the portion of the advertisement. with the value of the metric.

Implementations of the disclosure can include one or more of the following features. In some implementations, the time of the request includes a first time, and tracking includes: tracking the values for the metric from the first time to a second time; and the method further includes: detecting, based on tracking, a change in a value of the metric from the first time to the second time; and generating, based on the value of the metric at the second time, data for updating the value of the metric in the advertisement. In other implementations, the method further includes receiving a template for generation of the advertisement, the template including a field to be populated with the value of the metric.

In some implementations, populating includes: generating, from the template, the advertisement, with the advertisement including the field; and populating the field with the value of the metric. In other implementations, the metric includes an amount of time remaining for purchase of a product referenced in the advertisement at a discounted price. In still other implementations, tracking includes: detecting that a predefined period of time has elapsed; and adjusting the value of the metric by the predefined period of time.

In some implementations, the metric includes a quantity of a product referenced in the advertisement that is available for purchase. In other implementations, tracking includes: detecting a sale of the product; and adjusting the value of the metric by a quantity of the product sold.

In still another aspect of the disclosure, one or more machine-readable media are configured to store instructions that are executable by one or more processing devices to perform operations including tracking values of a metric to be displayed in a portion of an advertisement; receiving a request for the advertisement; determining, based on tracking, a value of the metric at a time of the request; and populating the portion of the advertisement with the value of the metric. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: tracking values of a metric to be displayed in a portion of an advertisement; receiving a request for the advertisement; determining, based on tracking, a value of the metric at a time of the request; and populating the portion of the advertisement with the value of the metric. Implementations of this aspect of the present disclosure can include one or more of the foregoing features.

In yet another aspect of the disclosure, an electronic system includes means for tracking values of a metric to be displayed in a portion of an advertisement; means for receiving a request for the advertisement; means for determining, based on tracking, a value of the metric at a time of the request; and means for populating the portion of the advertisement with the value of the metric. Implementations of this aspect of the present disclosure can include one or more of the foregoing features.

All or part of the foregoing can be implemented as a computer program product. including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE DRAWINGS

FIG. 1 is a block diagram of an example environment in which an advertisement management system manages advertising services.

FIG. 2 is a block diagram showing examples of components of the example environment in which the advertisement management system manages advertising services,

FIG. 3 is a flow diagram of a process for tracking values of metrics displayed in an advertisement,

FIG. 4 is a flow diagram of a process for generating an advertisement that displays values of metrics being tracked for the advertisement.

FIG. 5 shows an example of a computer device and a mobile computer device that can be used to implement the techniques described herein.

Like reference numbers and designations in the various drawings indicate like elements.

### DETAILED DESCRIPTION

A system consistent with this disclosure tracks values of a metric to be displayed in an advertisement. Generally, a metric includes a measure of a quantifiable characteristic. There are numerous types of metrics, including, e.g., a metric for measuring time, a metric for measuring a quantity of a product, and so forth.

In an example, an advertiser uses an advertisement to promote a product at a discounted price. In this example, the discounted price is offered for a limited period of time and is set to expire on an expiration data. The advertiser configures the advertisement to display details of the product, including, e.g., a quantity of the product available for purchase at the discounted price. The advertiser also configures the advertisement to display details pertaining to the discount, including, e.g., an amount of time remaining before expiration of the discount.

In this example, the system tracks values of metrics indicative of a quantity of the product available for purchase at the discounted price and an amount of time remaining before expiration of the discount. When the system sends the advertisement to a computing device for display, the system includes in the advertisement the values of the metrics, e.g., at a time when the advertisement was requested by the computing device.

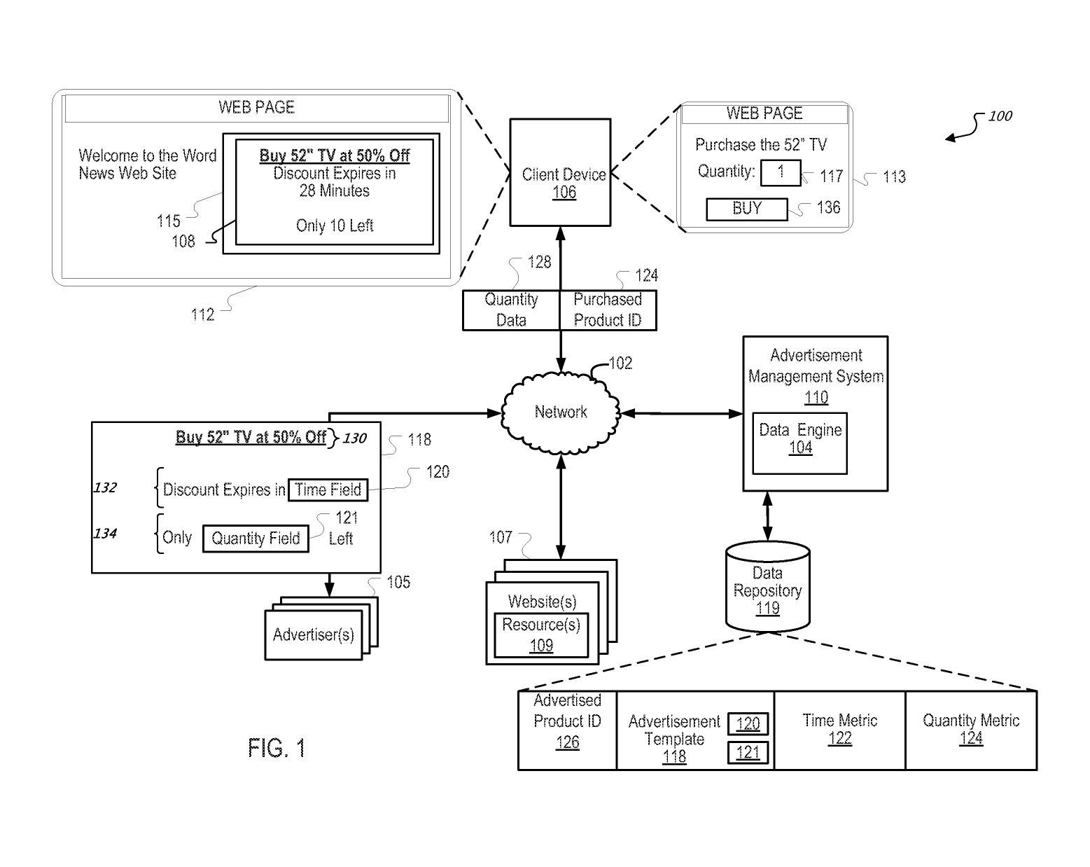

FIG. 1 is a block diagram of an example environment 1100 in which an advertisement management system 110 manages advertising services. The example environment 100 includes a network 102, including, e.g., a local area network (LAN), a wide area network (WAN), the Internet, or a combination thereof. The network 102 connects websites 107, a client device 106, advertisers 105, and the advertisement management system 110. The example environment 100 may include many thousands of websites 107, client devices (not shown), and advertisers 105.

The advertisement management system 110 includes a data engine 104 to implement the operations described herein. The example environment 100 also includes a data repository 119. In this example, the data repository 119 stores data uploaded to the advertisement management system 110 by the advertiser 105.

A website 107 includes one or more resources 109 associated with a domain name and hosted by one or more servers (not shown). An example website is a collection of web pages formatted in hypertext markup language (HTML) that include text, images, multimedia content, and programming elements, e.g., scripts. Generally, a script includes instructions that when executed by a computing device cause the computing device to perform one or more actions. A website 107 is maintained by a publisher (not shown), which is an entity that controls, manages and/or owns the website 107.

A resource 109 includes item(s) of data that can be provided over the network 102. A resource 109 is identified by a resource address that is associated with the resource 109. Resources 109 include HTML pages, word processing documents, portable document format (PDF) documents, images, videos, applications, feed sources, and so forth. The resources 109 can include content, words, phrases, images and sounds, embedded information (e.g., meta-information in hyperlinks) and/or embedded instructions JavaScript scripts).

The client device 106 is a computing device that is under control of a user (not shown) and is capable of requesting and receiving the resources 109 over the network 102. The client device 106 includes a personal computer, a mobile communication device, and other devices that can send and receive data over the network 102. The client device 106 typically includes an application, such as a web browser, to facilitate the sending and the receiving of data over the network 102.

In an example, advertisements (not shown) of the advertiser 105 may include static content, including, e.g., content that remains the same over a period of time. In this example, the advertiser 105 uploads the advertisements to the advertisement management system 110.

In another example, an advertisement 108 of the advertiser 105 may include dynamic content, including, e.g., content that changes over a period of time, In an example, a type of dynamic content includes values of metrics. In this example, the values of metrics may change over a period of time.

To promote display of the dynamic content in the advertisement 108, the advertiser 105 uploads an advertisement template 118 to the advertisement management system 10. Generally, an advertisement template includes data specifying a format for an advertisement, text to be displayed in the advertisement 108, and fields 120, 121 to be used in populating portions of the advertisement 108 with the dynamic content. Generally, a field includes a portion of a resource to be populated with data. The advertisement management system 110 stores the advertisement template 118 in the data repository 119.

In the example of FIG. 1, the advertisement template 118 is used in generating an advertisement 108 that promotes the sale of a product (“advertised product”), including, e.g., a television. In this example, the advertiser 105 offers the advertised product at a discounted price. The advertised product at the discounted price has an expiration date of Jun. 3, 2011 at 6 pm PDT.

The advertisement template 118 includes portion 130 with text promoting the sale of the advertised product at the discounted price (e.g., buy 52″ TV at 50% off). The advertisement template 118 also includes another portion 132 for the display of data specifying an amount of time remaining before the expiration date (e.g., discount expires in 28 minutes). The portion 132 of the advertisement template 118 includes text (e.g., discount expires in) and a time field 120. Generally, a time field includes a field for the display of a value of a metric indicative of an amount of time remaining before the expiration date (e.g., 28 minutes).

The advertisement template 118 also includes still another portion 134 for the display of data specifying a quantity of televisions remaining for purchase at the discounted price (e.g., only 10 left), The portion 134 of the advertisement template 118 also includes text (e.g., only and left) and a quantity field 121. Generally, a quantity field includes a field for the display of a value of a metric indicative of a quantity of the advertised product remaining for purchase (e.g., 10).

In an example, the advertiser 105 uses the time field 120 to specify start and end dates of the discount. In this example, the advertiser 105 may input into the time field 120 data specifying an expiration date for the purchase of the advertised good at the discounted price. As previously described, the expiration date includes a date of Jun. 3, 2011 at 6 pm PDT. In an example, the advertiser 105 may input into the time field 120 the following characters: expiration date=Jun. 3, 2011 at 6 pm PDT. The advertiser 105 may also input into the time field 120 data specifying a start date for the discounted price. For example, the advertiser 105 may specify that the discounted price (and an advertisement 108 referencing the discounted price) is offered a week after the advertiser 105 has uploaded the advertisement template 118 to the advertisement management system 110. Using the start date and the expiration date, the data engine 104 determines an amount of time remaining for purchase of the product at the discounted price. The data engine 104 populates the time field 120 with a value specifying the amount of time remaining for purchase of the product at the discounted price. Upon occurrence of the expiration date of the discounted price, the advertisement management system 110 is configured to disable the advertisement template 118 from participation in an auction.

The advertiser 105 may also input into the quantity field 121 data specifying an original quantity of televisions available or purchase at the discounted price. In this example, the advertiser 105 may input into the quantity field 121 the following characters: original quantity=fifty.

In another example, the advertiser 105 may upload with the advertisement template 118 a file (not shown) specifying the expiration date and the start date to be used by the advertisement management system 110 in computing a value of a metric for display in the time field 120. The file may also include data specifying the original quantity of televisions to be used by the advertisement management system 110 in computing a value of a metric for display in the quantity field 121.

In an example, the advertiser 105 may generate the advertisement template 118 by writing computer code to display the text specified in the portions 130, 132, 134 of the advertisement template 118 and computer code for generation of the time field 120 and the quantity field 121. In another example, the advertisement management system 110 may provide the advertiser 105 with a graphical user interface (not shown) through which the advertiser 105 can generate the advertisement template 118. In this example, the advertiser 105 can use the graphical user interface to specify the text included in the portions 130, 132, 134 of the advertisement template 118. The graphical user interface may also provide the advertiser 105 with icons representing the time field 120 and the quantity field 121, By dragging and dropping the icons into the advertisement template 118, the advertiser 105 can specify the portions 132, 134 of the advertisement template 118 that include the time field 120 and the quantity field 121.

The client device 106 sends the advertisement template 118 to the advertisement management system 110. In response to receiving the advertisement template 118, the data engine 104 generates an advertised product identifier (ID) 126 for the advertised product referenced in the advertisement template 118. In the example of FIG. 1, the advertiser 105 may upload with the advertisement template 118 data that uniquely identities the advertised product referenced in the advertisement template 118. In this example, the data engine 104 generates the advertised product ID 126 using the data that uniquely identities the advertised product referenced in the advertisement template 118.

In another example, the data engine 104 may use the contents of the advertisement template 118 in generating the advertised product ID 126. In this example, the data engine 104 may use a name of the advertised product referenced in the advertisement template 118 in generating the advertised product ID 126. The data engine 104 may also use other characteristics of the advertised product referenced in the advertisement template 118 in generating the advertised product ID 126.

The data engine 104 stores the advertised product ID 126 in the data repository 119. The data engine 104 also generates a pointer (not shown) between the advertisement template 118 and the advertised product ID 126. Generally, a pointer includes a reference among items of data,

The data engine 104 also tracks numerous metrics pertaining to the advertised product. In the example of FIG. 1, the data engine 104 generates a time metric 122, including, e.g., a metric indicative of an amount of time remaining before expiration of the discounted price. The data engine 1104 also generates a quantity metric 124, including, e.g., a metric indicative of a quantity of the advertised product available for purchase. The time metric 122 and the quantity metric 124 are associated with the advertisement template 118 and/or with the advertised product ID 126, e.g., through pointers.

In the example of FIG. 1, the data engine 104 generates the time metric 122 and the quantity metric 124 following detection of the time field 120 and the quantity field 121, respectively, in the advertisement template 118. In this example, the data engine 104 detects the time field 120 and the quantity field 121 based on identifiers in the advertisement. template 118 that specify inclusion of the time field 120 and the quantity field 121 in the advertisement template 118.

In an example, the advertisement template 118 includes code defining the time field 120, including, e.g., the following characters: time field=value of time metric; start date=May 3, 2011 at 6 pm PDT; expiration date=Jun. 3, 2011 at 6 pm PDT. In this example, the characters of “time field” are an identifier for the time field 120. The characters of “time field=value of time metric” specify a value of the time field 120, namely, that the time field 120 is populated with a value of the time metric 122. The characters of “start date=May 3, 2011 at 6 pm. PDT” specify the start date of the discounted price of the advertised good. The characters of “expiration date=Jun. 3, 2011 at 6 pm PDT” specify an expiration date for the discounted price of the advertised good, as previously described.

Through detection of the characters of “time field” in the advertisement template 118, the data engine 104 determines that the advertisement template 118 includes the time field 120. In response to detection of the time field 120, the data engine 104 generates the time metric 127.

In the example of FIG. 1, a value of the time metric 122 is initialized to an initialization time, including, e.g., an amount of time from the start date of the discount to the expiration date of the discount. The values of the time metric 122 are formatted as follows: dd:hh:mm:ss. In this example, the characters “dd” specify a portion of the time metric 122 indicative of a number of days remaining before the expiration date of the discount. The characters “hh” specify a portion of the time metric 122 indicative of a number of hours remaining before the expiration date of the discount. The characters “mm” specify a portion of the time metric 122 indicative of a number of minutes remaining before the expiration date of the discount. The characters “ss” specify a portion of the time metric 122 indicative of a number of seconds remaining before the expiration date of the discount.

In an example, the advertiser 105 may also specify how a value of the time metric 122 is displayed in the advertisement 108. In an example, the advertisement management system 110 may provide the advertiser 105 with a graphical user interface (not shown) with controls for the advertiser 105 to specify the display of the value of the time metric 122. In an example, the advertiser 105 may specify that when there is more than one day remaining for the discount that the dd portion of the time metric 122 be displayed (e.g., 3 days left). In another example, the advertiser 105 may specify that when there is less than a day remaining before expiration of the discount that the hh portion of the time metric 122 be displayed (e.g., 4 hours left). The advertiser 105 may also specify that when there is less than an hour remaining before expiration of the discount that the mm portion of the time metric 122 be displayed (e.g., 52 minutes left). The advertiser 105 may also specify that when there is less than a minute remaining before expiration of the discount that the ss portion of the time metric 122 be displayed (e.g., 30 seconds left).

In an example, the expiration date occurs thirty days after the start date. In this example, the initialization time is thirty days and the time metric 122 is initialized to the following value: 30:00:00:00. In another example, the discount expires an hour after the start of the discount. In this example, the initialization time is one hour and the time metric 122 is initialized to the following value: 00:01:00:00.

Following the start date of the discount, the data engine 1104 tracks values for the time metric 122 and the quantity metric 124. In an example, the data engine 104 adjusts a value of the time metric 122 based on a predefined period of time that has elapsed from the start date. The data engine 104 may adjust the time metric 122 in one second intervals, e.g., for each second that has elapsed from the start date of the discounted price. In an example, the time metric 122 is initialized to the following value: 30:00:00:00. In this example, one second after the start of the discount, the data. engine adjusts the value of the time metric 122 to the following value: 29:59:00:00.

The data engine 104 also generates the quantity metric 124 to indicate a remaining quantity of the advertised product. In the example of FIG. 1, the quantity metric 124 is initialized to a value indicative of an original quantity of the advertised product. As described above, the quantity field 121 of the advertisement template 118 may include a value indicative of the original quantity (e.g., original quantity=50). In this example, the data engine 104 initializes the quantity metric 124 to the value of the quantity field 121 when the advertisement template 118 is uploaded to the advertisement management system 110. Each time the advertised product is sold, the data engine 104 decreases a value of the quantity metric 124 by a value of one.

In an example, the original quantity of the advertised product is fifty. In this example, after the first sale of the advertised product, the data engine 1104 adjusts the value of the quantity metric 124 to a value of forty-nine.

The advertised product may be purchased through a web page (“product web page”). In the example of FIG. 1, the client device 106 accesses the product web page from a device (not shown) hosting the product web page. The client device 106 generates a graphical user interface 113 in which to render the product web page. The product web page may include a hidden field specifying a product ID of the purchased product (“purchased product ID 124”). Generally, a hidden field includes a field in a resource with a value that is not displayed when the resource is rendered by a client device. The graphical user interface 113 also includes an input box 117 for the input of quantity data 128, including, data specifying a quantity of the product being purchased. In the example of FIG. 1, the user inputs the number one into the input box 117 to indicate that the user is purchasing a single product. The user purchases the product through selection of a button 136 in the graphical user interface 113.

The product web page also includes instructions that when executed by the client device 106 cause the client device 106 to send to the advertisement management system 110 the purchased product ID 124 and the quantity data 128, e.g., following selection of the button 136. The advertisement management system 110 receives the quantity data 128 and the purchased product ID 124. In response, the data engine 104 searches in the data repository 119 to determine if an advertised product ID matches the purchased product ID 124.

In the example of FIG. 1, the data engine 104 determines that the purchased product ID 124 matches the advertised product ID 126. Based on the match, the data engine 104 determines that the advertised product referenced in the advertisement template 118 was purchased through the product web page. To determine a remaining quantity of the advertised product, the data engine 104 accesses the quantity metric 124 for the advertised product, e.g., using a pointer between the advertised product ID 126 and the quantity metric 124. The data engine 104 decreases the value of the quantity metric 124 by a value of the quantity data 128. In an example, the quantity metric 124 has a value of fifty, and the quantity data 128 has a value of one. Using the value of the quantity data 128, the data engine 104 decreases the value of the quantity metric 124 to a value of forty-nine.

In an example, the data engine 104 may use the advertisement template 118 in generating an advertisement 108 that is displayed in a resource 109. In this example, the client device 106 requests a resource 109 from the website 107. In response, a server (not shown) hosting the resource 109 sends the resource 109 to the client device 106 for presentation by the client device 106. The client device 106 generates a graphical user interface 112 in which to render the contents of the resource 109. As rendered in the graphical user interface 112, the resource 109 can also include an advertisement slot 115. Generally, an advertisement slot includes a portion of a resource in which advertisements can be presented.

When the client device 106 accesses the resource 109, the client device 106 also sends to the advertisement management system 110 a request (not shown) for advertisements to be provided with the resource 109. In response, the advertisement management system 110 executes an auction to determine an advertisement to display in the advertisement slot 115 of the resource 109. In this example, the advertisement template 118 is included in the auction as an advertisement.

In an example, the advertisement template 118 is the winner of the auction and is assigned the advertisement slot 115, Using the advertisement template 118, the data engine 104 generates the advertisement 108 for display in the advertisement slot 115. In the example of FIG. 1, the data engine 104 generates the advertisement 108 to include the text in the portions 130, 132, 134 of the advertisement template 118, the time field 120, and the quantity field 121. In advertisement 108, the data engine 104 populates the time field 120 with the value of the time metric 122. The data engine 104 also populates the quantity field 121 with the value of the quantity metric 124. The advertisement management system 110 sends the advertisement 108 to the client device 106 for display in the advertisement slot 115.

In this example, the values of the time metric 122 and the quantity metric 124 change during the time in which a user of the client device 106 views the advertisement 108. In this example, the data engine 104 is configured to refresh the contents of the advertisement 108 as the values of the time metric 122 and the quantity metric 124 change. For example, as a value of the time metric 122 changes (e.g., for each second that elapses from the start date of the discounted price), the data engine 104 generates data for updating the value of the time field 120 in the advertisement 108. The data engine 104 sends the data to the client device 106, causing the time field 120 in the advertisement 108 to be updated with the updated value of the time metric 122.

In the example of FIG. 1, a portion of the advertisement 108 is selectable. In an example, the portion that is selectable includes a hyperlink. Selection of the hyperlink causes the client device 106 to request a landing page associated with the advertisement 108. In the example of FIG. 1, the product web page is a landing page of the advertisement 108. As previously described, a user may purchase the advertised product through the product web page, e.g., causing the value of the quantity metric 124 to decrease. In another example, the user may directly access the product web page, e.g., rather than be directed to the product web page following selection of the hyperlink of the advertisement 108.

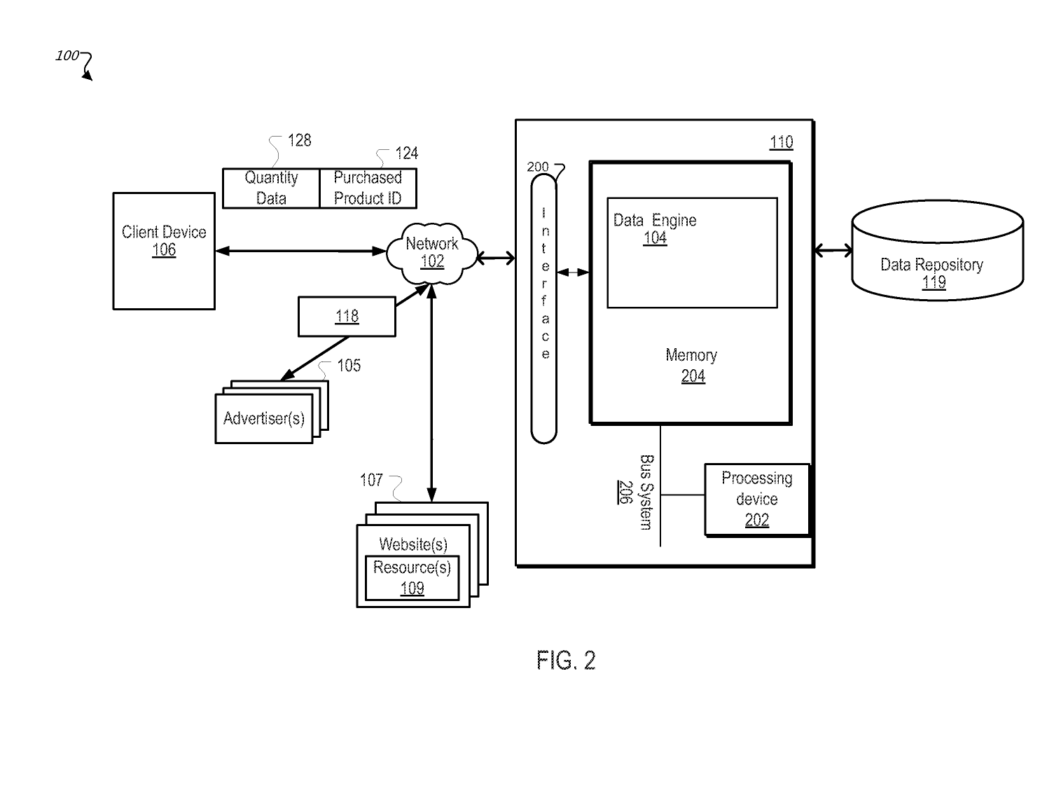

FIG. 2 is a block diagram showing examples of components the example environment 100 in which the advertisement management system 110 manages advertising services. In the example of FIG. 2, the contents of the advertisement template 118, the contents of the data repository 119, the graphical user interfaces 112, 113 and the contents of the graphical user interfaces 112, 113 are not shown.

The advertisement management system 110 can be a variety of computing devices capable of receiving data and running one or more services, which can be accessed by the client device 106. In an example, the advertisement management system 110 can include a server, a distributed computing system, a desktop computer, a laptop, a cell phone, a rack-mounted server, and the like. The advertisement management system 110 can be a single server or a group of servers that are at a same location or at different locations. The advertisement management system 110 and the client device 106 can run programs having a client-server relationship to each other. Although distinct modules are shown in the figures, in some examples, client and server programs can run on the same device.

The advertisement management system 110 can receive data from the client device 106 through input/output (I/O) interface 200. I/O interface 200 can be a type of interface capable of receiving data over a network, including, e.g., an Ethernet interface, a wireless networking interface, a fiber-optic networking interface, a modem, and so forth. The advertisement management system 110 also includes a processing device 202 and memory 204. A bus system 206, including, for example, a data bus and a motherboard, can be used to establish and to control data communication between the components of the advertisement management system 110.

Processing device 202 can include one or more microprocessors. Generally, processing device 202 can include an appropriate processor and/or logic that is capable of receiving and storing data, and of communicating over a network (not shown). Memory 204 can include a hard drive and a random access memory storage device, including, e.g., a dynamic random access memory, or other types of non-transitory machine-readable storage devices. As shown in FIG. 2, memory 204 stores computer programs that are executable by processing device 202. These computer programs may include a data engine 104 for implementing the operations and/or the techniques described herein. The data engine 104 can be implemented in software running on a computer device (e.g., the advertisement management system 110), hardware or a combination of software and hardware.

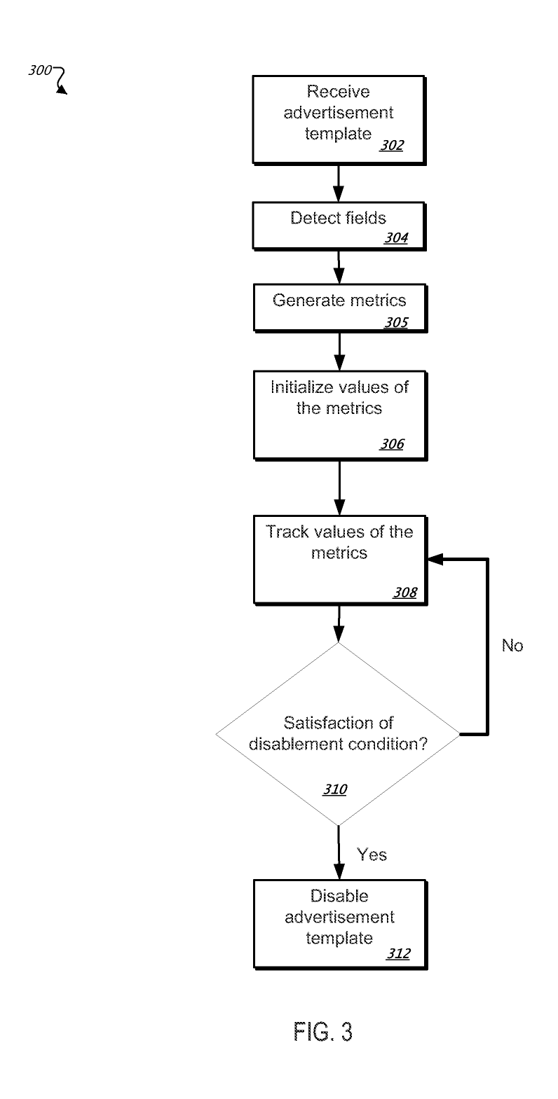

FIG. 3 is a flow diagram of a process 300 for tracking values of metrics displayed in the advertisement 108. In operation, the advertisement system 110 receives (302) the advertisement template 118. In response, the data engine 104 detects (304) an occurrence of the time field 120 and the quantity field 121 in the advertisement template 118. As previously described, the data engine 104 may detect the time field 120 and the quantity field 121 based on identifiers included in the advertisement template 118. In an example, code for the advertisement template 118 includes the characters of “time field.” In this example, the characters of “time field” are an identifier for the time field 120.

Based on detection of the time field 120 and the quantity field 121, the data engine 106 generates (305) the time metric 122 and the quantity metrics 124. As previously described, the time metric 122 includes a metric indicative of an amount of time remaining before expiration of the discounted price. The quantity metric 124 includes a metric indicative of a quantity of the advertised product available for purchase. The data engine 104 initializes (306) the values of the time metric 122 and the quantity metric 124, respectively, e.g., using the techniques previously described.

The data engine 104 also tracks (308) values for the time metric 122 and the quantity metric 124. In an example, the data engine 104 adjusts a value in the time metric 122 based on an amount of time that has elapsed, e.g., since the start date for the discounted price. In another example, the data engine 104 also adjusts a value of the quantity metric 124, e.g., based on a quantity of the advertised product that has been sold, as specified in the quantity data 128.

The data engine 104 also determines (310) whether a disablement condition of the advertisement template 118 has occurred. Generally, a disablement condition includes data specifying criteria for disablement of the advertisement template 118. In an example, the advertisement template 118 may be disabled by removing the advertisement template 118 from a group of advertisements participating in an auction (e.g., an auction that selects an advertisement for placement in the advertisement slot 115).

In an example, a disablement condition may be based on the expiration date of the discounted price. In this example, the criteria for disablement of the advertisement template 118 includes an occurrence of the expiration date. The data engine 104 determines an occurrence of the expiration date when the value of the time metric 122 equals zero. Upon occurrence of the expiration date, the disablement condition for the advertisement template 118 has been satisfied, and the data engine 104 removes the advertisement template 118 from the auction.

In another example, a disablement condition may be based on a quantity of the advertised good that is available for purchase. In this example, the criteria for disablement of the advertisement template 118 includes a value of the quantity metric 124 equaling zero (e.g., there are no remaining quantities of the advertised good available for purchase). Upon occurrence of the quantity metric 124 having a value of zero, a disablement condition for the advertisement template 118 has been satisfied, and the data engine 104 removes the advertisement template 118 from the auction.

When the data engine 104 detects satisfaction of a disablement condition, the data engine 104 disables (312) the advertisement template 118 from being included in the auction. When the data engine 104 does not detect satisfaction of a disablement condition, the data engine 104 continues tracking the values of the time metric 122 and the quantity metric 124.

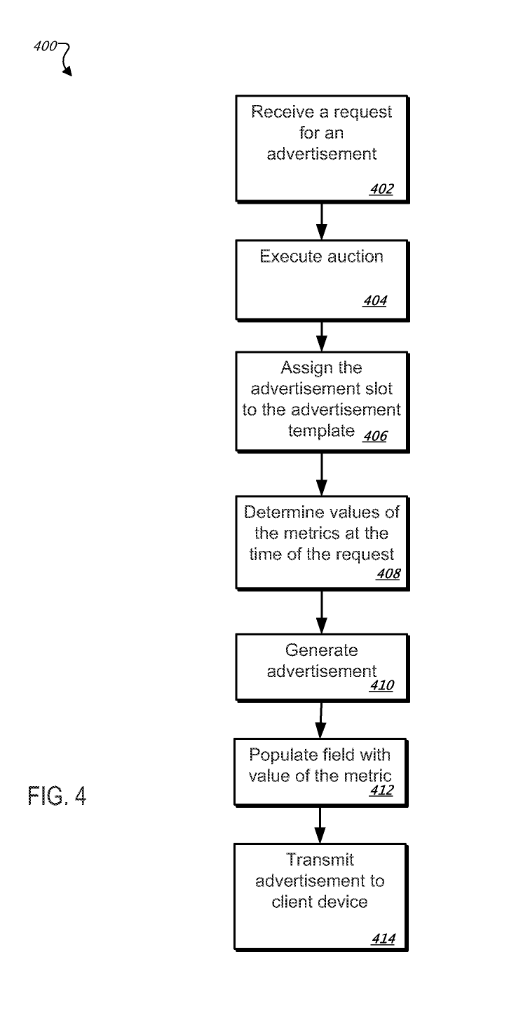

FIG. 4 is a flow diagram of a process 400 for generating an advertisement 108 that displays values of metrics 122, 124 being tracked for the advertisement 108. In operation, advertisement management system 110 receives (402) a request (not shown) for an advertisement to be displayed in the advertisement slot 115 of the resource 109. In response, the data engine 104 executes (404) an auction. As previously described, the advertisement template 118 is included in the auction. Based on results of the auction, the data engine 104 determines that the advertisement template 118 is a winner of the auction. The data engine 104 assigns (406) the advertisement slot 115 to the advertisement template 118.

The data engine 104 determines (408) values of the time metric 122 and the quantity metric 124, e.g., at a time of receipt of the request for an advertisement. Using the advertisement template 118, the data engine 104 generates (410) the advertisement 108 for display in the advertisement slot 115. In an example, the data engine 104 generates the advertisement 108 by generating a copy of the advertisement template 118. In this example, the advertisement 108 (e.g., the copy of the advertisement template 118) includes the time field 120 and the quantity field 121. The data engine 104 populates (412) the time field 120 with the value of the time metric 122 and the quantity field 121 with the value of the quantity metric 124. The data engine 104 transmits (414) the advertisement 108 to the client device 106, e.g., for presentation in the advertisement slot 115 rendered in the graphical user interface 112.

Using the techniques described herein, a system in configured to track values of a metric that is displayed in an advertisement, When the advertisement is requested, the system determines a value of the metric at the time of the request. The system also populates a field in the advertisement with the value of the metric and transmits the advertisement to a client device for presentation.

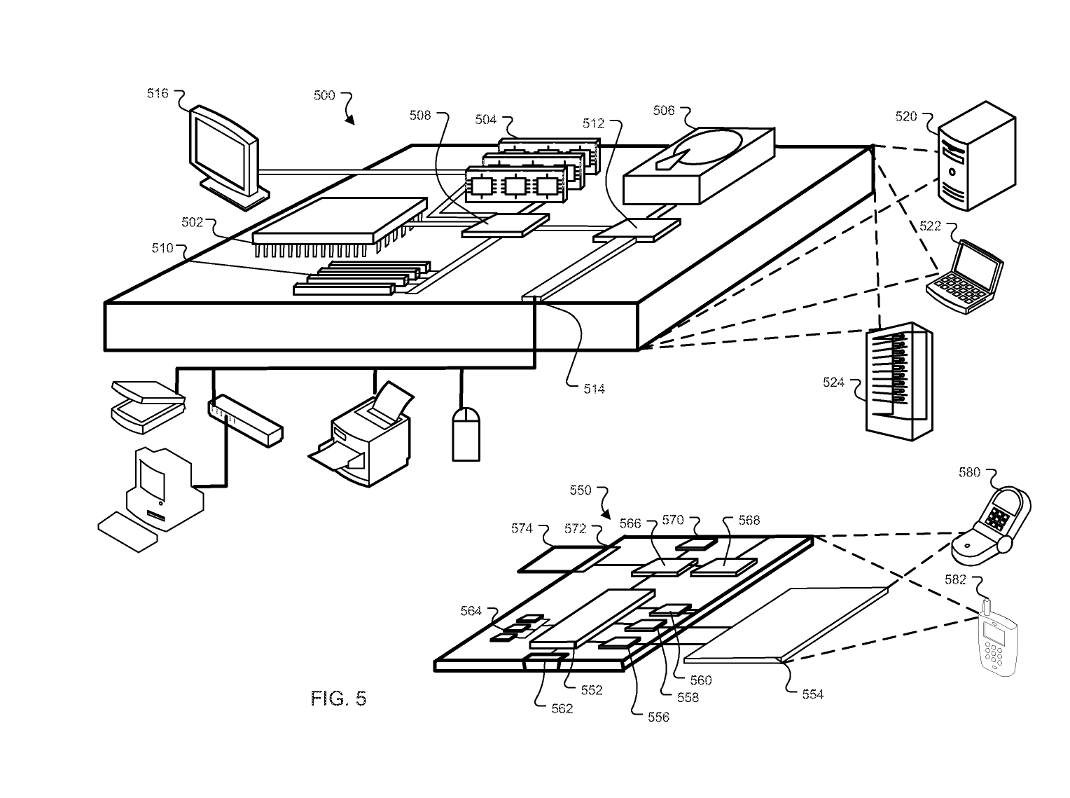

FIG. 5 shows an example of computer device 500 and mobile computer device 550, which can be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 500 includes processor 502, memory 504, storage device 506, high-speed interface 508 connecting to memory 504 and high-speed expansion ports 510, and low speed interface 512 connecting to tow speed bus 514 and storage device 506. Each of components 502, 504, 506, 508, 510, and 512, are interconnected using various busses, and can be mounted on a common motherboard or in other mariners as appropriate. Processor 502 can process instructions for execution within computing device 500, including instructions stored in memory 504 or on storage device 506 to display graphical data for a GUI on an external input/output device, such as display 516 coupled to high speed interface 508. In other implementations, multiple processors and/or multiple buses can be used, as appropriate, along with multiple memories and types of memory. Also, multiple computing devices 500 can be connected, with each device providing portions of the necessary operations (e.g., as a server bank, a group of blade servers, or a multi-processor system).

Memory 504 stores data within computing device 500. In one implementation, memory 504 is a volatile memory unit or units. In another implementation, memory 504 is a non-volatile memory unit or units. Memory 504 also can be another form of computer-readable medium, such as a magnetic or optical disk.

Storage device 506 is capable of providing mass storage for computing device 500. In one implementation, storage device 506 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an data carrier. The computer program product also can contain instructions that, when executed, perform one or more methods, such as those described above. The data carrier is a computer- or machine-readable medium, such as memory 504, storage device 506, memory on processor 502, and the like.

High-speed controller 508 manages bandwidth-intensive operations for computing device 500, while low speed controller 512 manages lower bandwidth-intensive operations. Such allocation of functions is an example only. In one implementation, high-speed controller 508 is coupled to memory 504, display 516 (e.g., through a graphics processor or accelerator), and to high-speed expansion ports 510, which can accept various expansion cards (not shown). In the implementation, low-speed controller 512 is coupled to storage device 506 and low-speed expansion port 514. The tow-speed expansion port, which can include various communication ports (e.g., USB, Bluetooth®, Ethernet, wireless Ethernet), can be coupled to one or more input/output devices, such as a keyboard, a pointing device, a scanner, or a networking device such as a switch or router, e.g., through a network adapter.

Computing device 500 can be implemented in a number of different forms, as shown in the figure. For example, it can be implemented as standard server 520, or multiple times in a group of such servers. It also can be implemented as part of rack server system 524. In addition or as an alternative, it can be implemented in a personal computer such as laptop computer 522. In some examples, components from computing device 500 can be combined with other components in a mobile device (not shown), such as device 550. Each of such devices can contain one or more of computing device 500, 550, and an entire system can be made up of multiple computing devices 500, 550 communicating with each other. Computing device 550 includes processor 552, memory 564, an input/output device such as display 554, communication interface 566, and transceiver 568, among other components. Device 550 also can be provided with a storage device, such as a microdrive or other device, to provide additional storage. Each of components 550, 552, 564, 554, 566, and 568, are interconnected using various buses, and several of the components can be mounted on a common motherboard or in other manners as appropriate.

Processor 552 can execute instructions within computing device 550, including instructions stored in memory 564. The processor can be implemented as a chipset of chips that include separate and multiple analog and digital processors. The processor can provide, for example, for coordination of the other components of device 550, such as control of user interfaces, applications run by device 550, and wireless communication by device 550.

Processor 552 can communicate with a user through control interface 558 and display interface 556 coupled to display 554. Display 554 can be, for example, a TFT LCD (Thin-Film-Transistor Liquid Crystal Display) or an OLED (Organic Light Emitting Diode) display, or other appropriate display technology. Display interface 556 can comprise appropriate circuitry for driving display 554 to present graphical and other data to a user. Control interface 558 can receive commands from a user and convert them for submission to processor 552. In addition, external interface 562 can communicate with processor 542, so as to enable near area communication of device 550 with other devices. External interface 562 can provide, for example, for wired communication in some implementations, or for wireless communication in other implementations, and multiple interfaces also can be used.

Memory 564 stores data within computing device 550. Memory 564 can be implemented as one or more of a computer-readable medium or media, a volatile memory unit or units, or a non-volatile memory unit or units. Expansion memory 574 also can be provided and connected to device 550 through expansion interface 572, which can include, for example, a SIMM (Single In Line Memory Module) card interface. Such expansion memory 574 can provide extra storage space for device 550, or also can store applications or other data for device 550. Specifically, expansion memory 574 can include instructions to carry out or supplement the processes described above, and can include secure data also. Thus, for example, expansion memory 574 can be provide as a security module for device 550, and can be programmed with instructions that permit secure use of device 550. In addition, secure applications can be provided via the SIMM cards, along with additional data, such as placing identifying data on the SIMM card in a non-hackable manner.

The memory can include, for example, flash memory and/or NVRAM memory, as discussed below. In one implementation, a computer program product is tangibly embodied in an data carrier. The computer program product contains instructions that, when executed, perform one or more methods, such as those described above. The data carrier is a computer-or machine-readable medium, such as memory 564, expansion memory 574, and/or memory on processor 552, that can be received, for example, over transceiver 568 or external interface 562.

Device 550 can communicate wirelessly through communication interface 566, which can include digital signal processing circuitry where necessary. Communication interface 566 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 568. In addition, short-range communication can occur, such as using a Bluetooth®, WiFi, or other such transceiver (not shown). In addition, GPS (Global Positioning System) receiver module 570 can provide additional navigation- and location-related wireless data to device 550, which can be used as appropriate by applications running on device 550.

Device 550 also can communicate audibly using audio codec 560, which can receive spoken data from a user and convert it to usable digital data. Audio codec 560 can likewise generate audible sound for a user, such as through a speaker, e.g., in a handset of device 550. Such sound can include sound from voice telephone calls, can include recorded sound (e.g., voice messages, music files, and the like) and also can include sound generated by applications operating on device 550.

Computing device 550 can be implemented in a number of different forms, as shown in the figure. For example, it can be implemented as cellular telephone 580. It also can be implemented as part of smartphone 582, personal digital assistant, or other similar mobile device.

Various implementations of the systems and techniques described here can be realized in digital electronic circuitry, integrated circuitry, specialty designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network.

The relationship of client and server arises by virtue of computer programs running on the respective computers and having a client-server relationship to each other.

A number of embodiments have been described. Nevertheless, it will be understood that various modifications can be made without departing from the spirit and scope of the processes and techniques described herein, in addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A method comprising:
receiving, by one or more processing devices on a network, a template for generation of an online advertisement of an advertiser, the template comprising a field to be populated with a metric;
detecting, by the one or more processing devices, an occurrence of the field in the template based on identifiers included in the template, wherein the identifiers specify inclusion of the field in the template, and wherein the identifiers are detected in characters of code included in the template;
generating, by the one or more processing devices, the metric;
initializing, by the one or more processing devices, the metric;
tracking, by the one or more processing devices, values for the metric to be displayed in a portion of the online advertisement of an advertiser for display in one or more webpages hosted by a third party, with the one or more processing devices associated with an entity that differs from each of the advertiser and the third party hosting the one or more webpages;
wherein the online advertisement provides a selectable portion for a user to select to access a web page that displays a product or a service that is advertised in the online advertisement;
disabling, by the one or more processing devices, the template, when the metric satisfies a disablement condition;
receiving, by the one or more processing devices and from a client computing device, (i) a request for an advertisement for display in the one or more webpages, and (ii) data specifying which advertisement slot in the one or more webpages is for display of the requested advertisement;
in response to the request,
selecting, from a data repository and by the one or more processing devices from among a plurality of candidate advertisements, the online advertisement with the metric for display in the one or more webpages, wherein the selected online advertisement is generated from a template that is not disabled;
determining, by the one or more processing devices and based on tracking, the value of the metric of the selected online advertisement at a time of the request;
transforming data indicative of a visual representation of the online advertisement by inserting, by the one or more processing devices, the determined value of the metric into the field of the online advertisement; and
transmitting, by the one or more processing devices to the client device, the transformed data indicative of the visual representation of the online advertisement with the value of the metric inserted into the field for display in the advertisement slot of the one or more webpages that are hosted by the third party.

2. The method of claim 1, wherein the time of the request comprises a first time, and wherein tracking comprises:
tracking the value for the metric from the first time to a second time;
wherein the method further comprises:
detecting, based on tracking, a change in the value of the metric from the first time to the second time; and
generating, based on the value of the metric at the second time, data for updating the value of the metric in the online advertisement.

3. (canceled)

4. The method of claim 3, further comprising:
generating, from the template, the online advertisement, with the online advertisement comprising the field.

5. The method of claim 1, wherein the metric comprises an amount of time remaining for purchase of the product referenced in the online advertisement at a discounted price.

6. The method of claim 5, wherein tracking comprises:
detecting that a predefined period of time has elapsed; and
adjusting the value of the metric by the predefined period of time.

7. The method of claim 1, wherein the metric comprises a quantity of the product referenced in the online advertisement that is available for purchase.

8. The method of claim 7, wherein tracking comprises:
detecting a sale of the product; and
adjusting the value of the metric by a quantity of the product sold.

9. One or more machine-readable hardware storage devices storing instructions that are executable by one or more processing devices to perform operations comprising:
receiving, by one or more processing devices on a network, a template for generation of an online advertisement of an advertiser, the template comprising a field to be populated with a metric;
detecting, by the one or more processing devices, an occurrence of the field in the template based on identifiers included in the template, wherein the identifiers specify inclusion of the field in the template, and wherein the identifiers are detected in characters of code included in the template;
generating, by the one or more processing devices, the metric;
initializing, by the one or more processing devices, the metric;
tracking, by the one or more processing devices, values for the metric to be displayed in a portion of the online advertisement of an advertiser for display in one or more webpages hosted by a third party, with the one or more processing devices associated with an entity that differs from each of the advertiser and the third party hosting the one or more webpages;
wherein the online advertisement provides a selectable portion for a user to select to access a web page that displays a product or a service that is advertised in the online advertisement;
disabling, by the one or more processing devices, the template, when the metric satisfies a disablement condition;
receiving, by the one or more processing devices and from a client computing device, (i) a request for an advertisement for display in the one or more webpages, and (ii) data specifying which advertisement slot in the one or more webpages is for display of the requested advertisement;
in response to the request,
selecting, from a data repository and by the one or more processing devices from among a plurality of candidate advertisements, the online advertisement with the metric for display in the one or more webpages, wherein the selected online advertisement is generated from a template that is not disabled;
determining, by the one or more processing devices and based on tracking, the value of the metric of the selected online advertisement at a time of the request;
transforming data indicative of a visual representation of the online advertisement by inserting, by the one or more processing devices, the determined value of the metric into the field of the online advertisement; and
transmitting, by the one or more processing devices to the client device, the transformed data indicative of the visual representation of the online advertisement with the value of the metric inserted into the field for display in the advertisement slot of the one or more webpages that are hosted by the third party.

10. The one or more machine-readable hardware storage devices of claim 9, wherein the time of the request comprises a first time, and wherein tracking comprises:
tracking the value for the metric from the first time to a second time;
wherein the method further comprises:
detecting, based on tracking, a change in the value of the metric from the first time to the second time; and
generating, based on the value of the metric at the second time, data for updating the value of the metric in the online advertisement.

11. (canceled)

12. The one or more machine-readable hardware storage devices of claim 11, wherein the operations further comprise:
generating, from the template, the online advertisement, with the online advertisement comprising the field.

13. The one or more machine-readable hardware storage devices of claim 9, wherein the metric comprises an amount of time remaining for purchase of the product referenced in the online advertisement at a discounted price.

14. The one or more machine-readable hardware storage devices of claim 13, wherein tracking comprises:
detecting that a predefined period of time has elapsed; and
adjusting the value of the metric by the predefined period of time.

15. The one or more machine-readable hardware storage devices of claim 9, wherein the metric comprises a quantity of the product referenced in the online advertisement that is available for purchase.

16. The one or more machine-readable hardware storage devices of claim 15, wherein tracking comprises:
detecting a sale of the product; and
adjusting the value of the metric by a quantity of the product sold.

17. An electronic system comprising:
receiving, by one or more processing devices on a network, a template for generation of an online advertisement of an advertiser, the template comprising a field to be populated with a metric;
detecting, by the one or more processing devices, an occurrence of the field in the template based on identifiers included in the template, wherein the identifiers specify inclusion of the field in the template, and wherein the identifiers are detected in characters of code included in the template;
generating, by the one or more processing devices, the metric;
initializing, by the one or more processing devices, the metric;
tracking, by the one or more processing devices, values for the metric to be displayed in a portion of the online advertisement of an advertiser for display in one or more webpages hosted by a third party, with the one or more processing devices associated with an entity that differs from each of the advertiser and the third party hosting the one or more webpages;
wherein the online advertisement provides a selectable portion for a user to select to access a web page that displays a product or a service that is advertised in the online advertisement;
disabling, by the one or more processing devices, the template, when the metric satisfies a disablement condition;
receiving, by the one or more processing devices and from a client computing device, (i) a request for an advertisement for display in the one or more webpages, and (ii) data specifying which advertisement slot in the one or more webpages is for display of the requested advertisement;
in response to the request,
selecting, from a data repository and by the one or more processing devices from among a plurality of candidate advertisements, the online advertisement with the metric for display in the one or more webpages, wherein the selected online advertisement is generated from a template that is not disabled;
determining, by the one or more processing devices and based on tracking, the value of the metric of the selected online advertisement at a time of the request;
transforming data indicative of a visual representation of the online advertisement by inserting, by the one or more processing devices, the determined value of the metric into the field of the online advertisement; and
transmitting, by the one or more processing devices to the client device, the transformed data indicative of the visual representation of the online advertisement with the value of the metric inserted into the field for display in the advertisement slot of the one or more webpages that are hosted by the third party.

18. The electronic system of claim 17, wherein the time of the request comprises a first time, and wherein tracking comprises:
tracking the value for the metric from the first time to a second time;
wherein the method further comprises:
detecting, based on tracking, a change in the value of the from the first time to the second time; and
generating, based on the value of the metric at the second time, data for updating the value of the metric in the online advertisement.

19. (canceled)

20. The electronic system of claim 19, wherein the operations further comprise:
generating, from the template, the online advertisement, with the online advertisement comprising the field.

21. The electronic system of claim 17, wherein the metric comprises an amount of time remaining for purchase of the product referenced in the online advertisement at a discounted price.

22. The electronic system of claim 21, wherein tracking comprises:
detecting that a predefined period of time has elapsed; and
adjusting the value of the metric by the predefined period of time.

23. The electronic system of claim 17, wherein the metric comprises a quantity of the product referenced in the online advertisement that is available for purchase.

24. The electronic system of claim 23, wherein tracking comprises:
detecting a sale of the product; and
adjusting the value of the metric by a quantity of the product sold.

25. (canceled)
